(19) United States
(12) Patent Application Publication
(10) Pub. No.: US 2007/0299702 A1
(43) Pub. Date: Dec. 27, 2007

(54) Implement IT service management processes

(76) Inventors: Roxanne R. Rigdon, Pekin, IL (US); Jennifer L. Hartsock, Goodfield, IL (US); Ronald S. Owdom, Morton, IL (US); Richard D. Getz, Morton, IL (US); Richard E. Munge, Pekin, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/472,451

(22) Filed: Jun. 22, 2006

(51) Int. Cl. G06F 17/50

(52) U.S. Cl. 705/7

(57) ABSTRACT

Consistent with an aspect of the present disclosure, customer IT-related requests are used to identify and prioritize standardized IT processes, such as those specified in the ITIL. In particular, based on the customer requests and associated correlation values, defined customer requirements are ranked, and those with the highest ranking are assigned corresponding metrics. Based on the metrics and additional correlation values, standardized IT processes, such as ITIL sub-functions, are assigned priority values and ranked accordingly. Those IT processes having the highest rankings, i.e., those that are most closely aligned with the customer's requests, are preferentially carried out.

### TECHNICAL FIELD

The present disclosure is directed toward a method for managing and maintaining a computer system.

### BACKGROUND

Large organizations, such as companies or universities, often have computer systems with a large number of users. As these computer systems have become increasingly complex, many companies, for example, have established information technology (IT) departments staffed with individuals who service and maintain such computer systems. An example of a service offered by an IT department is a so-called “help desk,” whereby customers can call for assistance with their individual computers.

In order to improve the quality of service offered by IT departments, guidelines or so-called “best practices” have been developed that identify processes for improving management efficiencies. One such guideline is the Information Technology Infrastructure Library (ITIL). ITIL is a series of books that describe processes for planning, delivering, and managing IT services. These processes include: Configuration Management; Incident Management, Change Management, Problem Management, Release Management, Service Level Management, Availability Management, Capacity Management, IT Service Continuity Management, and Financial Management. Each of these processes will be described in greater detail below.

Configuration Management relates to identification, recording, and reporting all IT components in a system, and includes, for example, creating a parts list of each hardware and software component in the system.

Incident Management involves restoration of normal service operation as quickly as possible after an “incident,” whereby an incident is defined, by ITIL, as an event which is not part of the standard operation of a service and which causes, or may cause, an interruption to, or a reduction in, the quality of service.

Change Management employs standardized methods and procedures for efficient and prompt handling of all system changes, in order to minimize the impact of change-related incidents upon service quality.

Problem Management minimizes the adverse impact of incidents and problems on business that are caused by errors within the IT infrastructure, and to prevent recurrence of incidents related to these errors.

Release Management relates to processes that insure that hardware and software, which are distributed within the system, are licensed, tested, and certified.

Service Level Management provides for continual identification, monitoring and reviews of IT services specified in a Service Level Agreement with a customer.

Availability Management maintains IT service availability at a cost acceptable to the customer.

Capacity Management supports optimal provisioning of IT services by matching IT resources with the business demands of the customer.

IT Service Continuity Management ensures the availability and rapid restoration of IT services in the event of a disaster.

Financial Management assess the cost of providing IT services.

The above-noted ITIL processes have a relatively large number of associated sub-functions that further define particular tasks for the management and maintenance of the computer system. ITIL, however, does not prioritize or rank the sub-functions, and there is no indication in ITIL that one sub-function may be more significant than another. Accordingly, it is difficult to identify which sub-functions may correspond to a particular customer request, thereby resulting in inefficient and inadequate provisioning of IT services.

U.S. Pat. No. 7,003,502 (the '502 patent) describes a method for knowledge management through establishment of “communities,” such as an IT department in an organization. Knowledge is then shared within each community and amongst the communities. The '502 patent, however, does not describe how to prioritize standard IT procedures and methodologies, such as ITIL sub-functions, in light of a customer's requests.

The present disclosure is directed to overcome one or more of the shortcomings in the prior art.

### SUMMARY OF THE INVENTION

Consistent with an aspect of the present disclosure, a method is provided of managing a computer system operated by a customer. The method includes receiving a plurality of requests from the customer, and generating a first plurality of priority values based on first correlation values associated with the plurality of requests and a plurality of requirements associated with the management of the computer system. The method also includes assigning each of the first plurality of priority values to a corresponding one of the plurality of requirements, and selecting a subgroup of requirements from the plurality of requirements based on the first plurality of priority values. In addition, the method includes assigning each of a plurality of metrics to a corresponding one of the subgroup of the plurality of requirements, and generating a second plurality of priority values based on second correlation values associated with the plurality of metrics and a plurality of processes associated with the management or maintenance of the computer system. The method further includes assigning each of the second plurality of priority values to a corresponding one of the plurality of processes and selecting a subgroup of processes from the plurality of processes based on the second plurality of priority values.

Consistent with an additional aspect of the present disclosure, a method is provided for managing a computer system operated by a customer. The method includes receiving a plurality of requests from the customer, and ranking a plurality of Information Technology Infrastructure Library (ITIL) sub-functions based on the plurality of requests from the customer. The ITIL sub-functions have associated ranking values. In addition, the method includes carrying out selected ones of the plurality of ITIL sub-processes. The selected ones of the plurality of ITIL sub-functions have higher ranking values than remaining ones of the plurality of ITIL sub-functions.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a computer system consistent with an aspect of the present disclosure;

FIG. 2 illustrates a flowchart of a method consistent with an additional aspect of the present disclosure;

FIGS. 3a-3d illustrate a table consistent with a further aspect of the present disclosure;

FIG. 4 shows another table consistent with an aspect of the present disclosure;

FIGS. 5a-5e illustrate an additional table consistent with an additional aspect of the present disclosure;

FIG. 6 illustrates another table consistent with an aspect of the present disclosure; and

FIG. 7 illustrates an example of a process flow for carrying out ITIL processes.

### DETAILED DESCRIPTION

Reference will now be made in detail to the present preferred embodiments of the invention, examples of which are illustrated in the accompanying drawings. Wherever possible, the same reference numbers will be used throughout the drawings to refer to the same or like parts.

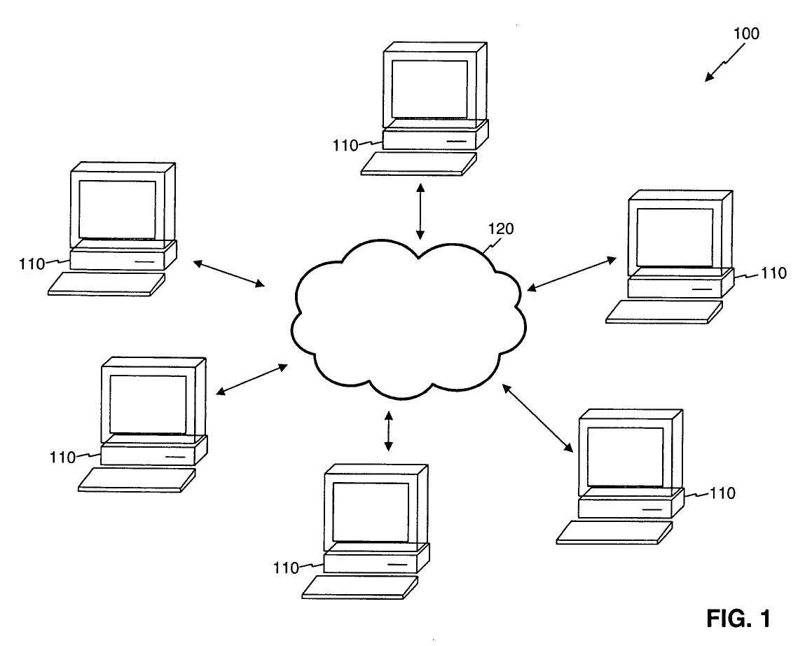

FIG. 1 illustrates a computer system 100 including, for example, a plurality of computers 110, which may be operated by a customer. The computers may be interconnected through a network 120. As noted above, computer system 100 may be managed and maintained in accordance with standardized “best practices” or processes, such as those articulated in the ITIL. Such standardized processes are not easily associated with customer request. For example, a customer may request that a “computer system needs to be as reliable as Amazon.com or CBSnews.com.” Such reliability criteria are not set forth in this manner in the ITIL, for example, and thus can potentially result in the misapplication of IT services.

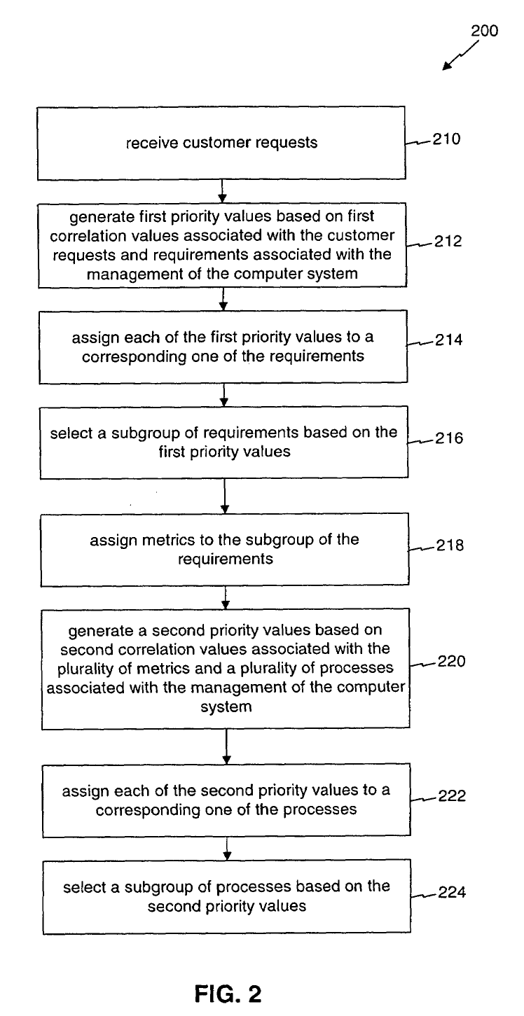

A method for identifying those IT processes that are most relevant to customer requests will next be described with reference to flowchart 200 shown in FIG. 2. In an initial step 210 of the method, customer requests are received. Next, in step 212, first priority values are generated based on first correlation values associated with the customer requests and defined requirements associated with the management of the computer system. In particular, each customer request is assigned an importance value, which is then multiplied by a corresponding one of a subgroup of correlation values. The subgroup of correlation values is associated with a particular requirement. The resulting products are summed to yield a first priority value corresponding to the particular requirement. Additional first priority values are obtained in a similar fashion by multiplying each importance value by respective correlation values in other subgroups and then adding the resulting products.

In step 214, each of the first priority values is assigned a corresponding one of the requirements, and a subgroup of the requirements is selected based on the first priority values (step 216). For example, the requirements may be ranked by first priority values so that those requirements with the highest first priority values are selected. That is, the top 80% of first priority values may be associated with the selected subgroup of requirements, while the non-selected requirements may have corresponding priority values in the bottom 20%. Other percentile breakdowns are contemplated consistent with the present disclosure.

Next, a corresponding metric is assigned to each requirement in the selected subgroup (step 218). These metrics quantify criteria by which the selected subgroup of requirements are satisfied. For example, if the requirement is that the computer system be highly available from 6 AM to 6 PM each day, a corresponding metric may be that the system has less than two minutes of unplanned outages during those times each day.

In step 220, second priority values are generated based on second correlation values associated with the plurality of metrics and a plurality of processes associated with management of the computer system. Typically, the processes are standardized processes or sub-functions, such as those associated with the ITIL. The second priority values may be obtained by first assigning each metric a corresponding ranking value. Each second correlation value within a subgroup of second correlations values (corresponding to one of the standardized processes) is then multiplied by a corresponding ranking value. The resulting products are summed to yield one of the second priority values, which is associated with the process corresponding to the subgroup of correlation values. Other second priority values are obtained in a similar fashion by multiplying each second correlation value within a subgroup of second correlation values associated with a given process by a respective ranking value, and then adding the resulting products.

Each of the second priority values is assigned to a corresponding one of the plurality of processes (step 222), and a subgroup of processes are selected based on the second priority values (step 224). Namely, the plurality of processes may be ranked based on second priority values, such that those processes with the highest second priority values constitute the subgroup while those with lower second priority values are deselected.

Thus, based on the customer's requests, processes are ranked, and those with the highest ranking are selected and implemented. Accordingly, the selected processes are deemed to satisfy the customer's requests, and as a result, resources can be efficiently allocated to the selected processes.

### INDUSTRIAL APPLICABILITY

Consistent with an aspect of the present disclosure, customer IT-related requests are used to identify and prioritize standardized IT processes, such as those specified in the ITIL. In particular, based on the customer requests and associated correlation values, defined customer requirements are ranked, and those with the highest ranking are assigned corresponding metrics. Based on the metrics and additional correlation values, standardized IT processes, such as ITIL sub-functions, are assigned priority values and ranked accordingly. Those IT processes having the highest rankings, i.e., those that are most closely aligned with the customer's requests, are preferentially carried out.

Accordingly, all components of an IT service which are necessary to meet a particular customer need can be readily identified. As a result, the IT service can be more efficiently provided in a manner that is more responsive to the customer's requests.

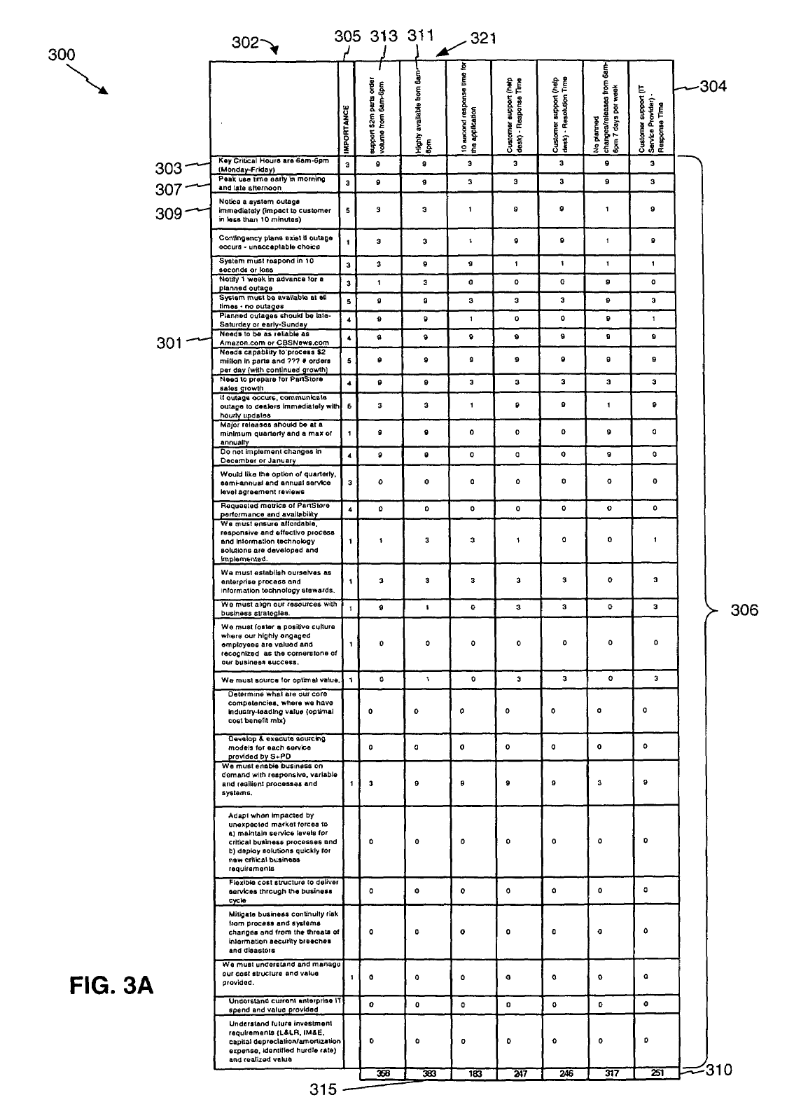

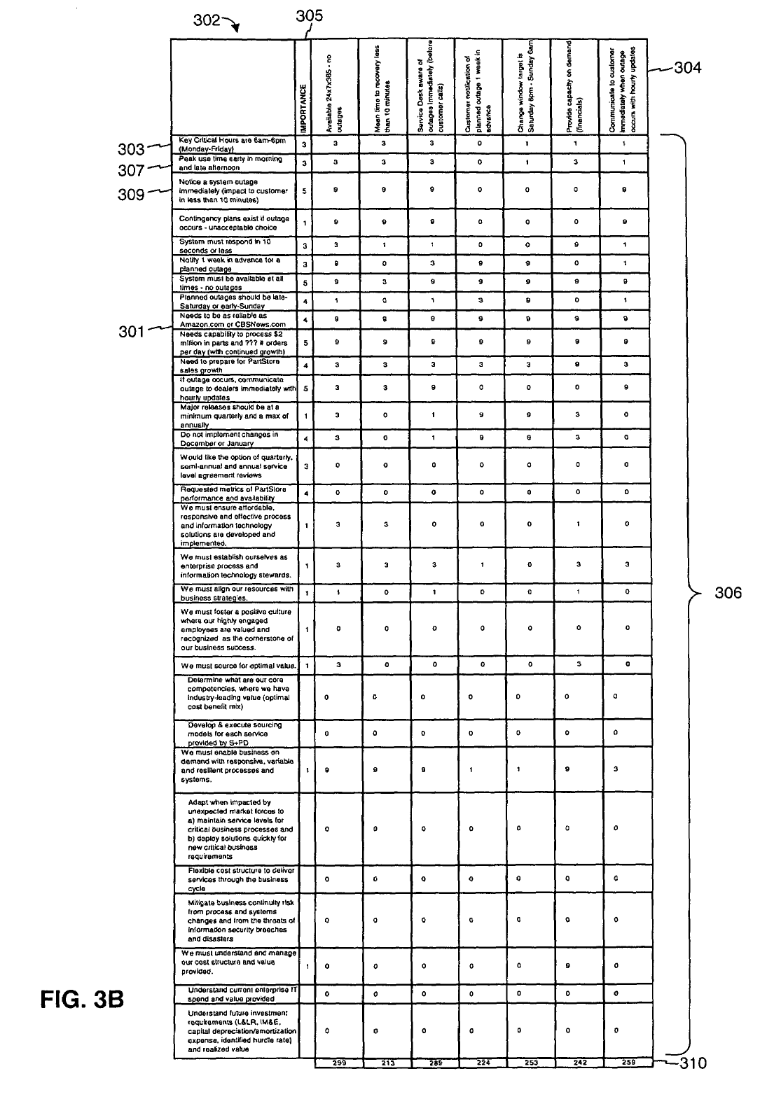

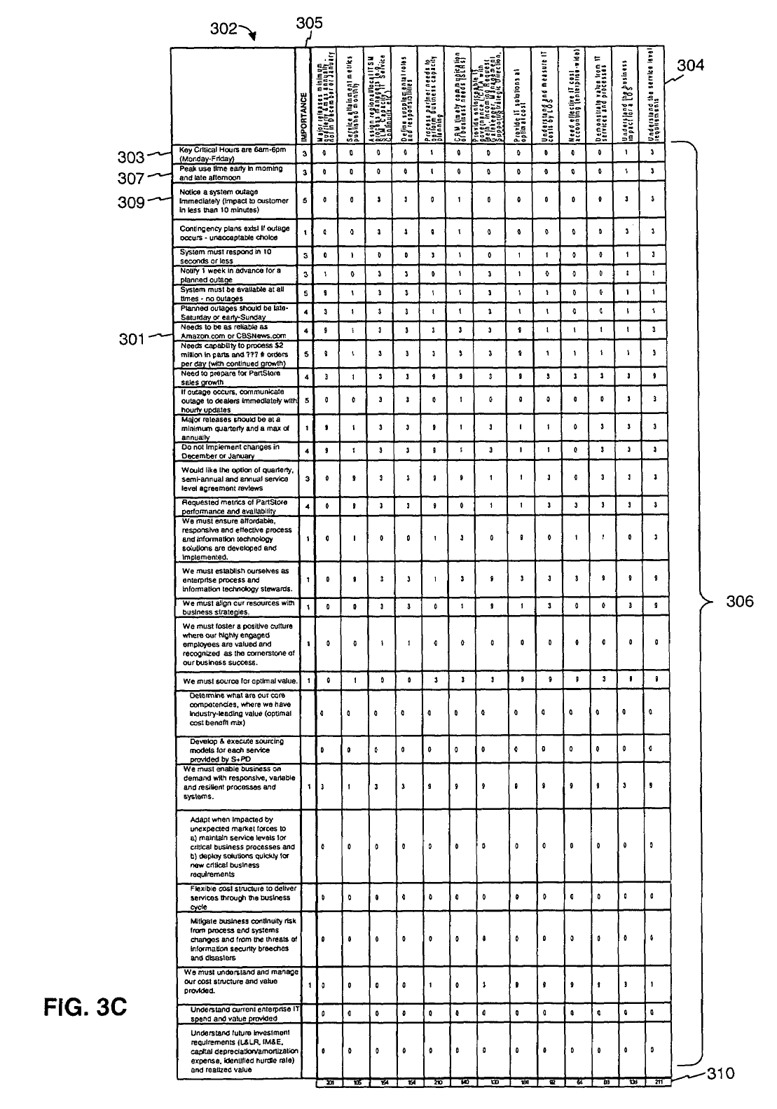

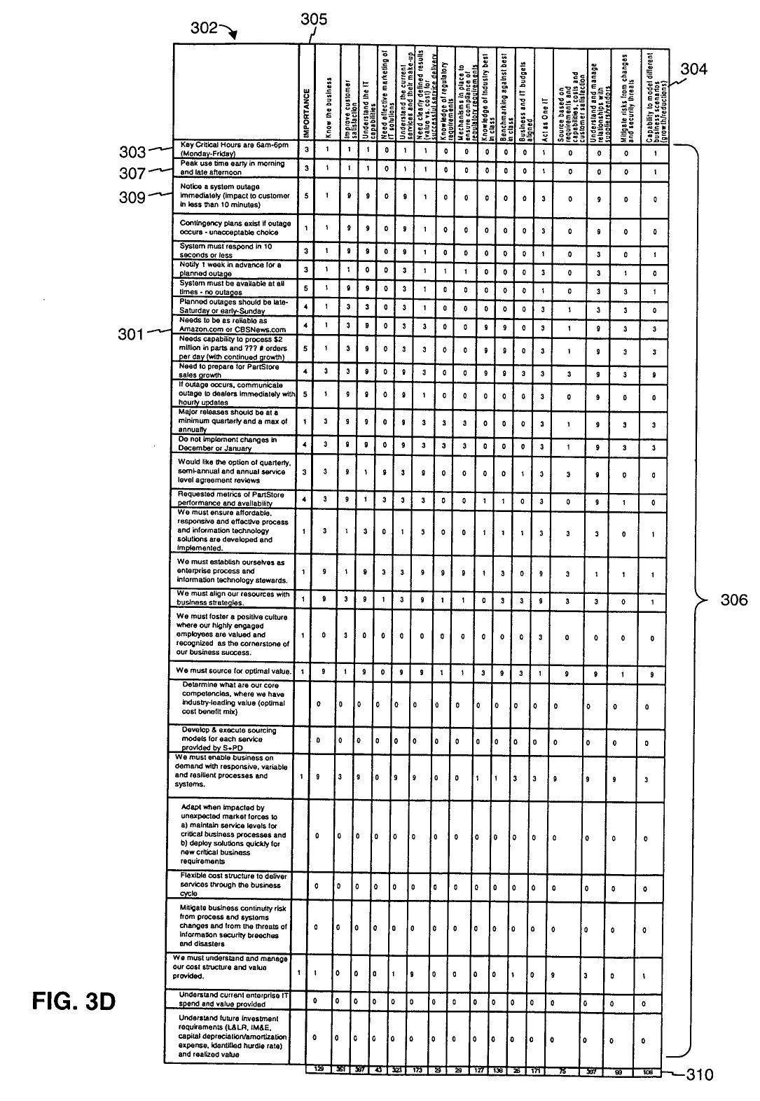

An example of a method consistent with an aspect of the present disclosure will next be described with reference to FIGS. 3a-3d, 4, 5a-5e, and 6.

FIGS. 3a-3d illustrate portions table 300 in which column 302 lists exemplary requests obtained from a customer (see step 210 above). For example, such requests include: “Needs to be as reliable as Amazon.com or CBSNews.com” (table entry 301); “Key Critical Hours are 6 am-6 pm (Monday-Friday)” (table entry 303); “Peak use time early in morning and late afternoon” (table entry 307). These customer requests typically do not conform to well-defined IT requirements, such as those listed in row 304.

Accordingly, as a first step in associating the customer requests in column 302 with standardized processes, the customer requests are preferably aligned or correlated with the requirements in row 304. Such correlation is achieved by obtaining importance values from the customer and associating each one with a corresponding customer request (see column 305). Thus, for example, the customer request “Notice a system outage immediately (impact to customer in less than 10 minutes)” (table entry 309) is deemed by the customer to have a relatively high importance value of 5, while the request “Key Critical Hours are 6 am-6 pm (Monday-Friday)” (table entry 303) has a lower importance value of 3.

Next, first correlation values (table entries 306) are assigned to each requirement in row 304 and a corresponding customer request in column 302. The correlation values are indicative of how strongly related a particular requirement is to a corresponding customer request. Accordingly, for example, the requirement “Highly available from 6 am-6 pm” (table entry 311) is strongly related to the customer request “Key Critical Hours are 6 am-6 pm (Monday-Friday)” (table entry 303) and has a first correlation value of 9 (see FIG. 3a). On the other hand, the requirement “support $2 m parts order volume from 6 am-6 pm” (table entry 313) is less strongly related to the customer request “Notice a system outage immediately (impact to customer in less than 10 minutes)” (table entry 309) and has a first correlation value of 3 (see FIG. 3a).

Once the first correlation values are assigned, each first correlation value in a given column in table 300 is multiplied by a corresponding importance value in column 305 to obtain the first priority values (see also step 212 above). The resulting products are then summed. Therefore, for example, each of first correlation values in column 321 is multiplied by a respective one of the importance values in column 305, and the products are summed to obtain a first priority value of 383 in row 310 (see table entry 315, FIG. 3a). Table entry 315 is thus a first priority value assigned to the requirement “Highly available from 6 am-6 pm” (table entry 311, FIG. 3a). Other first priority values are calculated in a similar fashion and assigned to the remaining requests listed in row 304 (see FIGS. 3a-3d, and step 214 above).

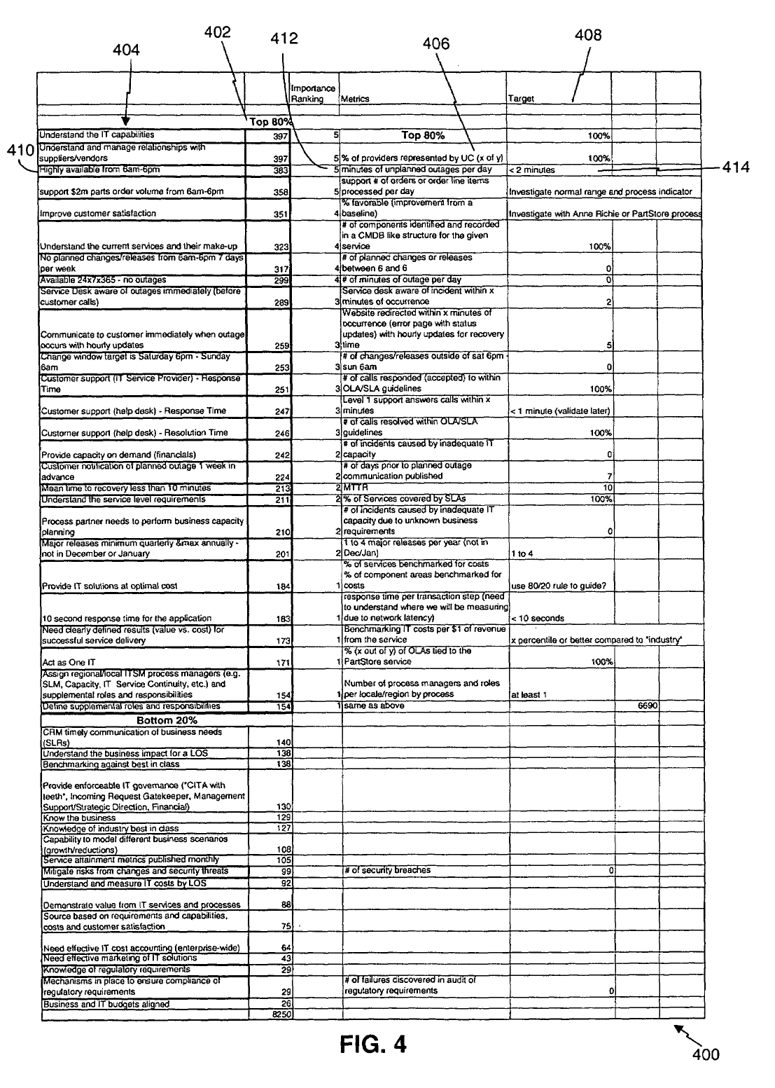

In FIG. 4, the first priority values are ranked in column 402 of table 400, and the corresponding requirements are similarly ranked in column 404. The top 80% first priority values/requirements are then selected (see also step 216 above) and assigned to corresponding metrics in column 406 (see also step 218). Optionally, each metric may be assigned a target or threshold by which performance may be measured (column 408). For example, the metric corresponding to the requirement “Highly available from 6 am-6 pm” (table entry 410) is the number of “minutes of unplanned outages per day” (table entry 412), and the target number of minutes of such unplanned outages per day is two (table entry 414).

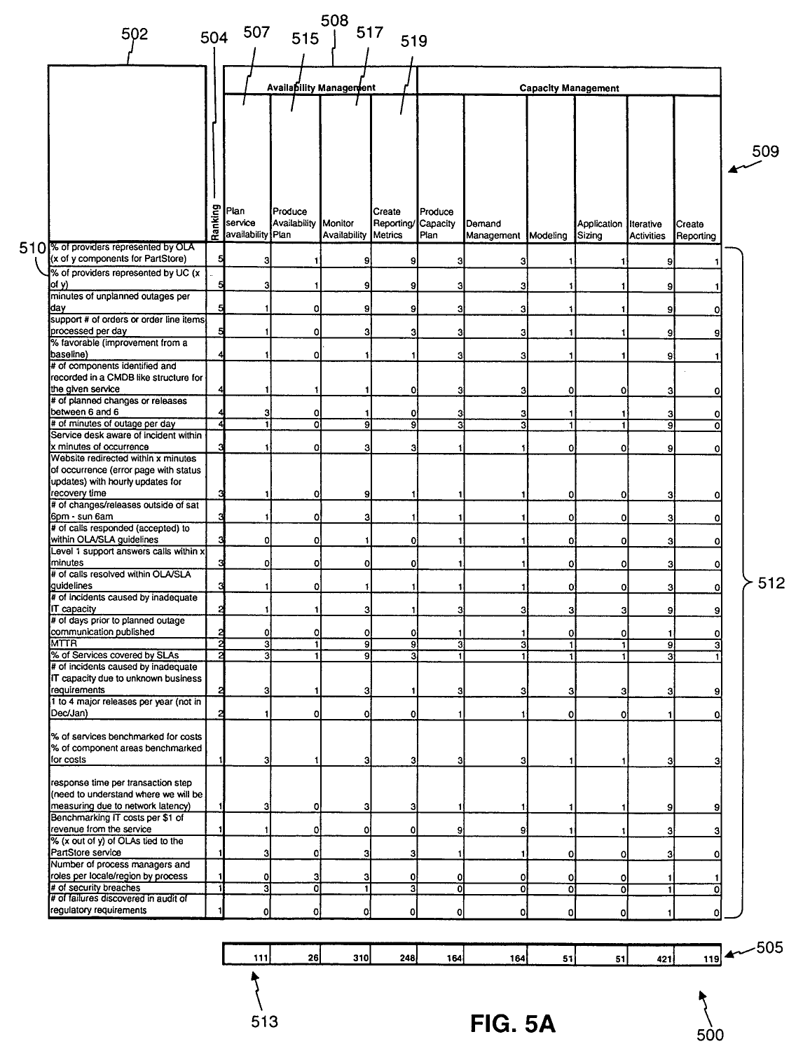

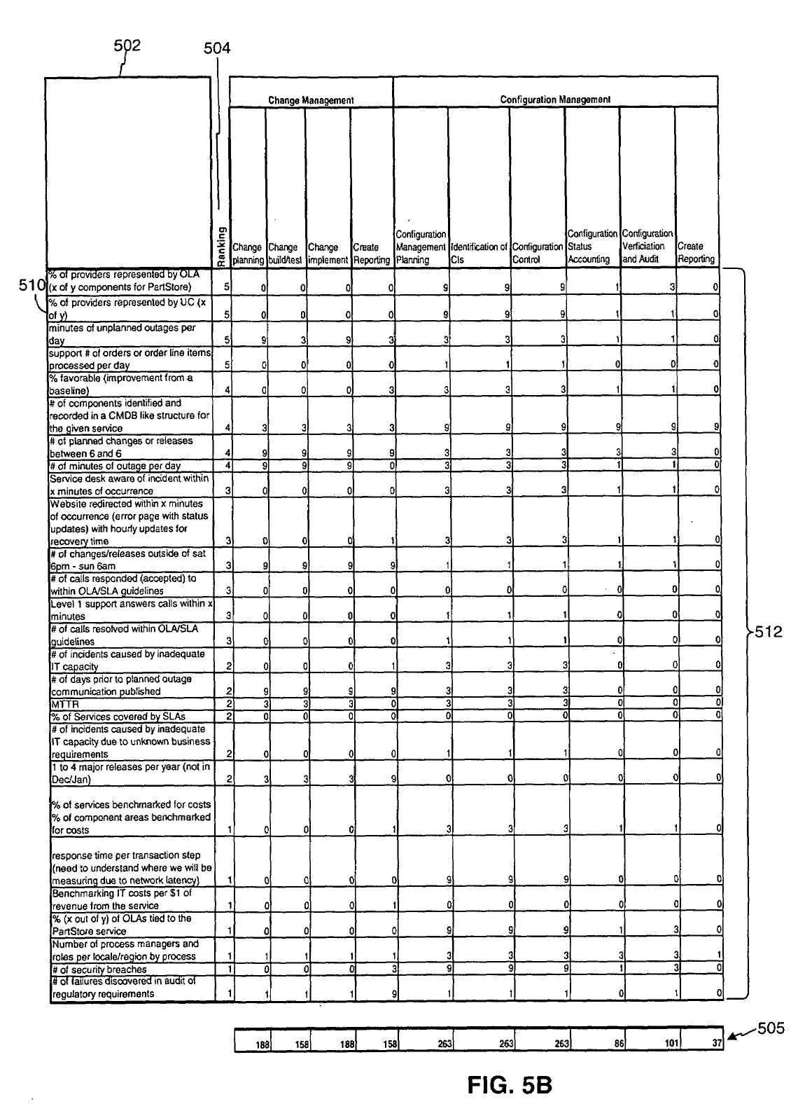

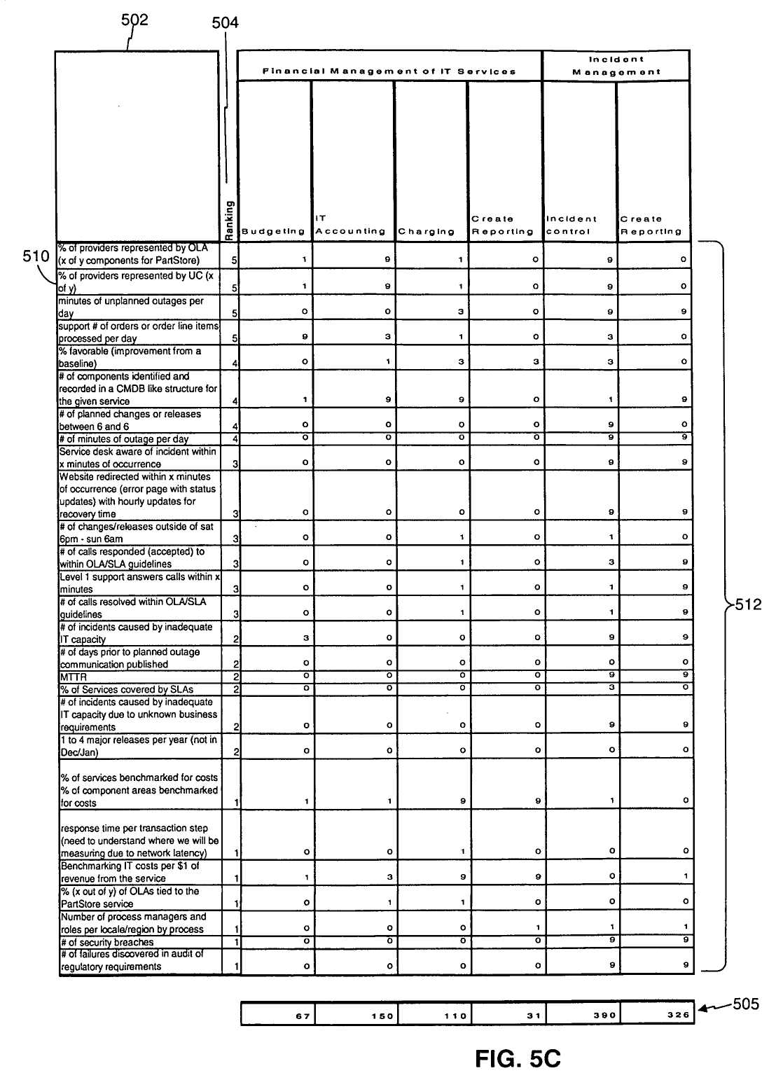

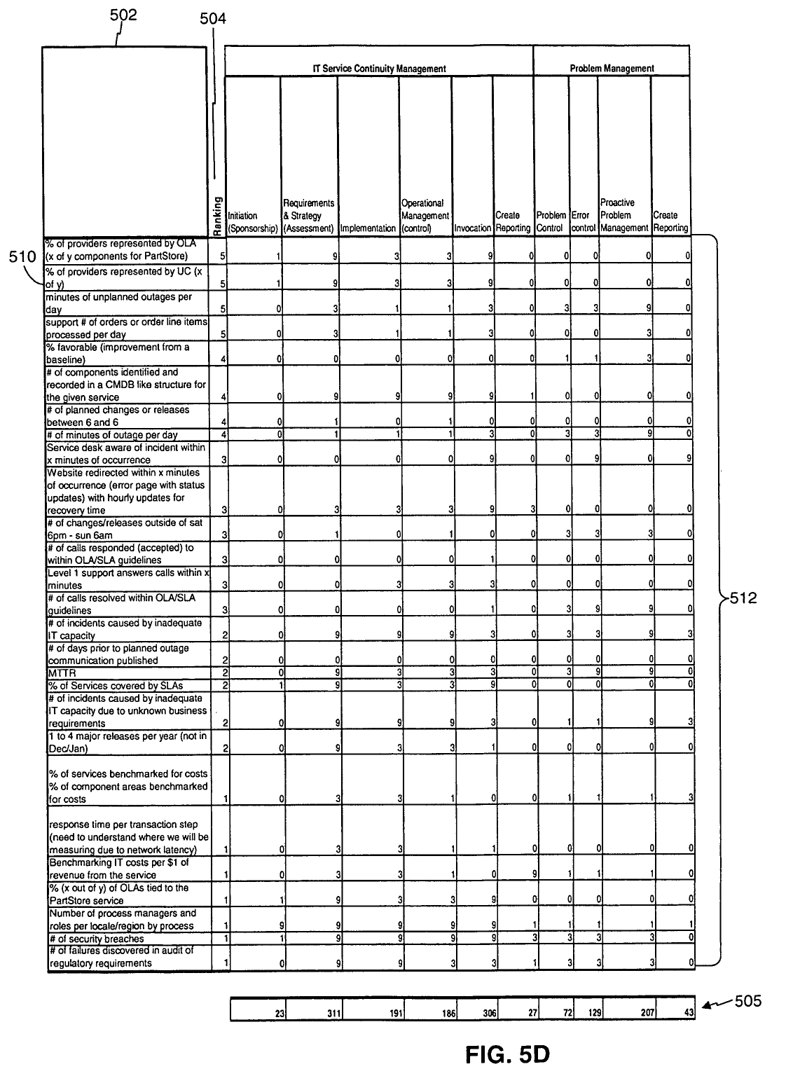

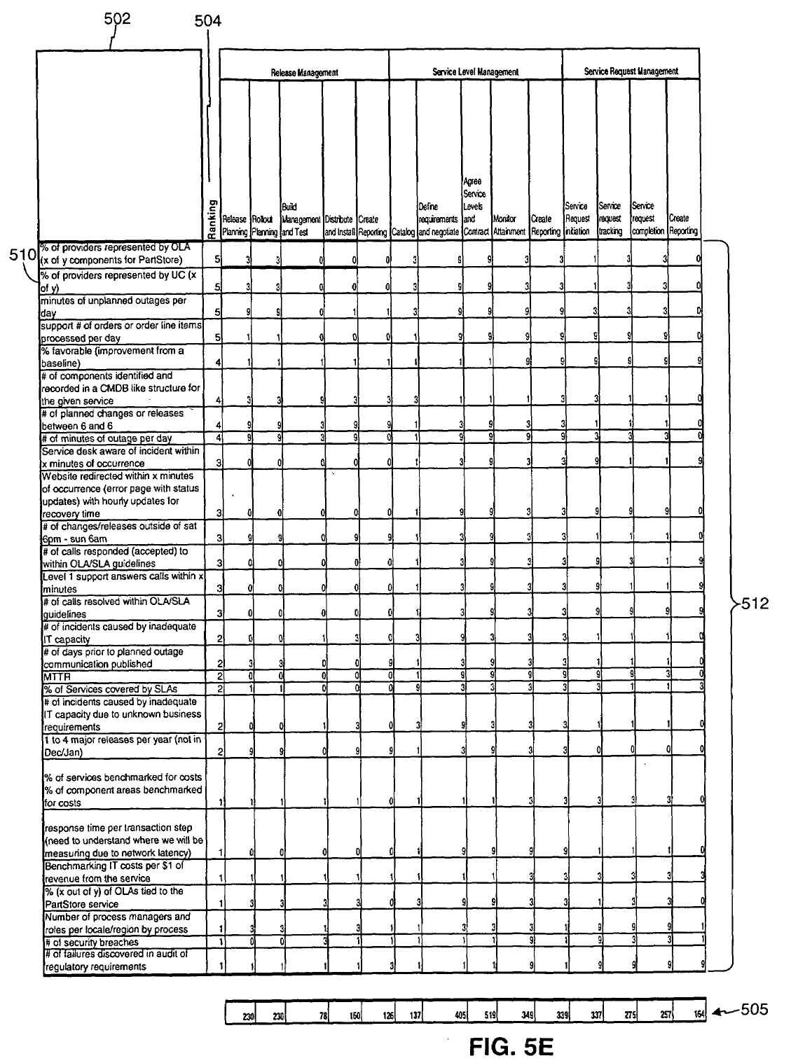

In FIGS. 5a-5e, which show portions of a table 500, the selected metrics are listed in column 502, and a corresponding ranking value for each is listed in column 504 of the table. The ranking values are obtained based on first priority values associated with each of the selected metrics. Accordingly, for example, those selected metrics with the top 20% first priority values are assigned a ranking value of “5”, the next 20% of the selected metrics are assigned a ranking value of “4”, and so on.

Row 509 of table 500 identifies ITIL processes, which constitute categories of sub-functions. For example, the ITIL process Availability Management has known associated sub-functions of plan service availability (planning the availability of IT services), produce availability plan (generate the availability plan), monitor availability (monitor IT services availability), and create reporting/metrics of the availability of IT services. Other known ITIL process and corresponding sub-functions are listed in column 509.

Certain sub-functions are strongly related to specific metrics such that those metrics could not be successfully achieved without direct involvement of the corresponding sub-functions. Such sub-functions and corresponding metrics are assigned a relatively high second correlation value. Accordingly, for example, the sub-function “monitor availability” (table entry 517) and the metric “% of providers represented by OLA [operation level agreements] (x or y components of PartStore” are strongly related and have an associated second correlation value of 9. Other metrics, however, require only indirect involvement of a particular sub-function, and are thus more weakly related. A lower second correlation value, therefore, represents this relationship. For example, the sub-function “plan service availability” (table entry 507) is only moderately related to the requirement “% of providers represented by UC [underpinning contract] (x of y)” (table entry 510), and thus this relationship has a lower second correlation value of 3. Even weaker relationships have second correlation values of 1, and when there is no relationship at all, the second correlation value is 0. The second correlation values for each of the remaining sub-functions in row 509 and requirements in column 502 are listed in table entries 512 in FIGS. 5a-5e. In FIGS. 5a-5e, “SLA” is an acronym for “service level agreement,” “CMDB” is an acronym for “configuration management database,” and “MTTR” is an acronym for “mean time to repair.”

Second priority values (row 505 in table 500) for each sub-function are calculated (see also step 220 above) by multiplying each second correlation value within a given column of table 500 by a respective ranking value, and then summing the resulting products. Each column of table 500 corresponds to a particular sub-function. Accordingly, for example, the second priority value of 111 (see row 505, FIG. 5a) associated with the sub-function “plan service availability” (table entry 507) is calculated by multiplying each second correlation value in column 513 (i.e., a subgroup of second correlation values) by a corresponding one of ranking values in column 504 (see FIG. 5a). The resulting products are then summed to yield the second priority value of 111. Remaining second priority values are calculated and assigned to other sub-functions listed in table 500 in a similar fashion (see also step 222 above). Each sub-function is preferably grouped according to its corresponding process. For example, sub-functions of plan-service availability (table entry 507), produce availability plan (table entry 515), monitor availability (table entry 517), and create reporting metrics (table entry 519) are grouped or associated with Process Availability Management (table entry 508).

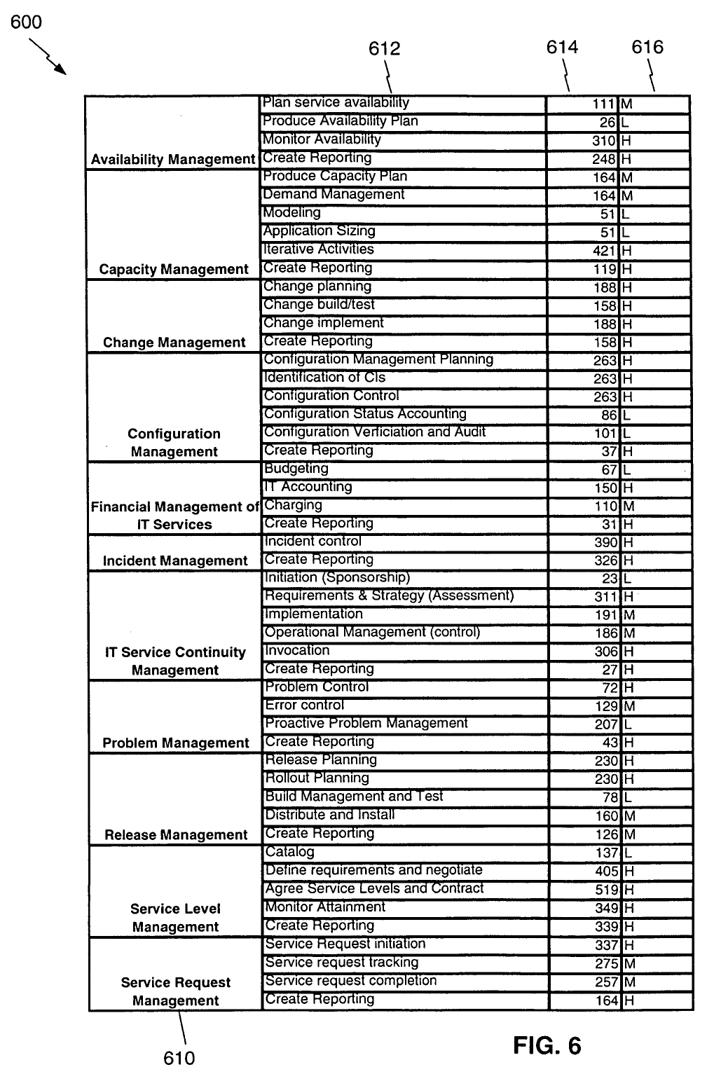

In FIG. 6, table 600 lists each ITIL process (column 610), associated sub-functions (column 612), and corresponding second priority values (column 614). The rank of each sub-function, based on the listed second priority values, is also provided in column 616. As further shown in FIG. 6, those sub-functions, such as “monitor availability,” MISSING Availability Management Row in FIG. 6—can't find “monitor availability” on figure having relatively high second priority values, are assigned a high ranking or “H” in column 616. In addition, those sub-functions having lower second priority values are assigned ranks of middle (“M”) and those with the lowest are assigned ranks of low (“L”). Typically, those sub-functions (i.e., a subgroup of sub-functions or processes) having a rank of M or H are selected to be implemented and carried out (see also step 224 above).

As generally understood, different ITIL process can be related to other ITIL process such that the result of a particular sub-function is fed as an input to another sub-function. For example, the result of the “create reporting” sub-function within the Availability Management process can be used by the “monitor attainment” sub-function of the Service Level Management process. Consistent with an aspect of the present disclosure, not all sub-functions are required to be carried out in order to satisfy the customer's request. Accordingly, only those sub-functions, selected in the manner discussed above, need be applied, and the outputs or results of such sub-functions are supplied to other selected sub-functions. Accordingly, a more efficient implementation of ITIL sub-functions can be realized.

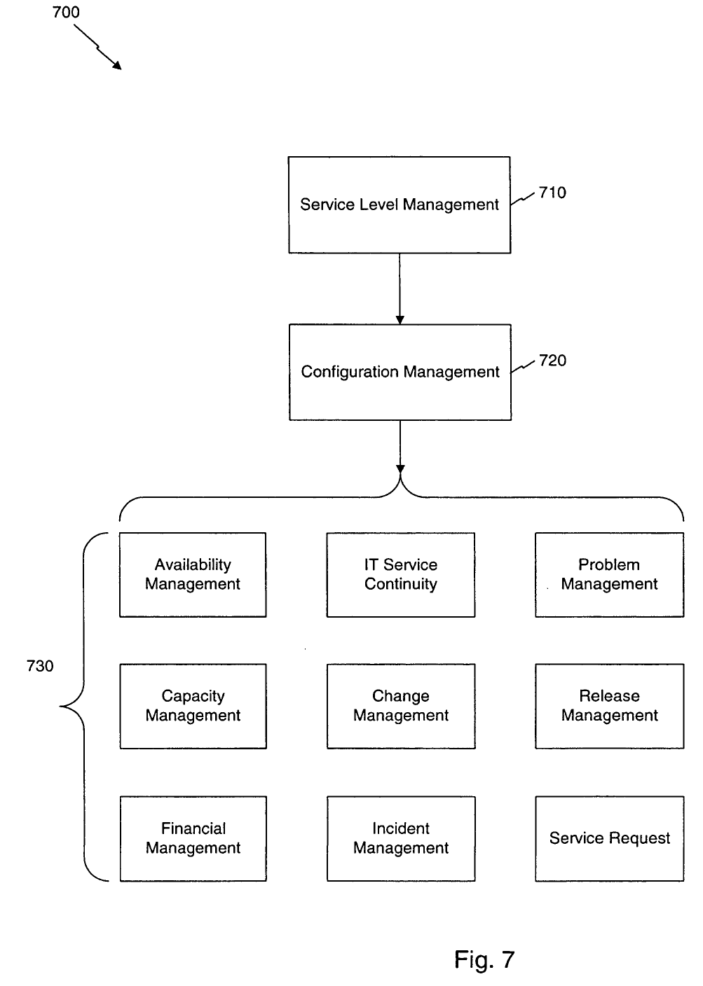

As noted above, the outputs of the sub-functions of various ITIL processes often serve as inputs to sub-functions of other ITIL processes. Typically, the results of the sub-functions associated with the Service Level Management process are used as inputs to most other ITIL processes. In addition, the outputs of the sub-functions associated with the Configuration Management process are also used as inputs to many other sub-functions. Accordingly, consistent with a further aspect of the present disclosure, the Service Level Management and Configuration Management processes are preferably carried out before other ITIL process. As shown in process flow 700 of FIG. 7, the Service Level Management process is performed in a first step (710) prior to the Configuration Management process (step 720). Once these two processes are completed and in place, other ITIL processes can be implemented (step 730), such as: Availability Management, IT Service Continuity, Problem Management, Capacity Management, Change Management, Release Management, Financial Management, Incident Management, and Service Request. Process flow 700 provides even greater efficiency for carrying out ITIL processes.

Accordingly, consistent with the present disclosure, customer requests are used to prioritize and select ITIL processes and sub-functions so that those requests can be more adequately responded to. In addition, greater efficiencies can be achieved by IT departments by supplying the results of selected sub-functions as inputs to other selected sub-functions. Lastly, a preferred sequence of performing ITIL processes is disclosed which can further improve the effectiveness of an IT department in providing services to the customer.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of managing a computer system, the computer system being operated by a customer, the method comprising:
receiving a plurality of requests from the customer;
generating a first plurality of priority values based on first correlation values associated with the plurality of requests by the customer and a plurality of requirements associated with the management of the computer system;
assigning each of the first plurality of priority values to a corresponding one of the plurality of requirements;
selecting a subgroup of requirements from the plurality of requirements based on the first plurality of priority values;
assigning each of a plurality of metrics to a corresponding one of the subgroup of the plurality of requirements;
generating a second plurality of priority values based on second correlation values associated with the plurality of metrics and a plurality of processes associated with the management of the computer system;
assigning each of the second plurality of priority values to a corresponding one of the plurality of processes; and
selecting a subgroup of processes from the plurality of processes based on the second plurality of priority values.

2. A method in accordance with claim 1, wherein the selecting the subgroup of requirements includes ranking the plurality of requirements in accordance with the plurality of first priority values.

3. A method in accordance with claim 1, wherein selected ones of the first plurality of priority values associated with the subgroup of the plurality of requirements are greater than remaining ones of the first plurality of priority values.

4. A method in accordance with claim 1, wherein the selecting the subgroup of the plurality of processes includes ranking the plurality of processes in accordance with the second plurality of priority values.

5. A method in accordance with claim 1, wherein selected ones of the second plurality of priority values associated with the subgroup of the plurality of processes are greater than remaining ones of the second plurality of priority values.

6. A method in accordance with claim 1, wherein each of the plurality of processes is an Information Technology Infrastructure Library (ITIL) sub-function.

7. A method in accordance with claim 1, wherein the generating the first plurality of priority values includes:
obtaining importance values from the customer;
identifying subgroups of the first correlation values, each of the subgroups of first correlation values being associated with a corresponding one of the plurality of requirements;
multiplying each of the first correlation values within each of the subgroups of first correlation values by a respective one of the importance values to generate pluralities of products; and
adding each product within each of the pluralities of products to obtain a plurality of sums, each of the plurality of sums being equal to a corresponding one of the first plurality of priority values.

8. A method in accordance with claim 1, wherein the generating the second plurality of priority values includes:
obtaining ranking values;
identifying subgroups of the second correlation values, each of the subgroups of second correlation values being associated with a corresponding one of the plurality of processes;
multiplying each of the second correlation values within each of the subgroups of second correlation values by a respective one of the ranking values to generate pluralities of products; and
adding each product within each of the pluralities of products to obtain a plurality of sums, each of the plurality of sums being equal to a corresponding one of the second plurality of priority values.

9. A method in accordance with claim 8, wherein selected ones of the ranking values are higher than remaining ones of the ranking values.

10. A method in accordance with claim 9, wherein the selected ones of the ranking values correspond to respective ones of the plurality of metrics, the respective ones of the plurality of metrics being associated with selected ones of the subgroup of the plurality of requirements.

11. A method in accordance with claim 1, further including implementing each of process in the subgroup of the plurality of processes.

12. A method in accordance with claim 1, wherein the plurality of processes are grouped into categories, the method further including assigning a ranking value to each process within each category based on the second priority values.

13. A method in accordance with claim 12, wherein each process within the selected subgroup of processes has a higher ranking value than remaining ones of the plurality of processes.

14. A method in accordance with claim 12, wherein each of the categories corresponds to one of a plurality of Information Technology Infrastructure Library (ITIL) processes, the plurality of ITIL processes including: Availability Management, Capacity Management, Change Management, Configuration Management, Financial Management, Incident Management, Information Technology (IT) Continuity Management, Problem Management, Release Management, Service Level Management, Service Request Management.

15. A method in accordance with claim 1, wherein the selected subgroup of processes includes ITIL sub-functions.

16. A method of managing or maintaining a computer system, the computer system being operated by a customer, the method comprising:
receiving a plurality of requests from the customer;
ranking a plurality of Information Technology Infrastructure Library (ITIL) sub-functions based on the plurality of requests from the customer, the plurality of ITIL sub-functions having associated ranking values; and
carrying out selected ones of the plurality of ITIL sub-functions, the selected ones of the plurality of ITIL sub-functions having higher ranking values than remaining ones of the plurality of ITIL sub-functions.

17. A method in accordance with claim 16, wherein the ranking is based on correlation values associated with the plurality of requests from the customer and requirements associated with the management of the computer system.

18. A method in accordance with claim 17, wherein the correlation values are first correlation values, the ranking being further based on second correlation values associated with metrics and the plurality of ITIL sub-functions, the metrics corresponding to the requirements.

19. A method of implementing Information Technology Infrastructure Library (ITIL) processes, comprising:
performing a Service Level Management process;
performing a Configuration Management process; and
after performing the Service Level Management and Configuration Management processes, performing an additional ITIL process.

20. A method in accordance with claim 19, wherein the additional ITIL process is selected from Availability Management, IT Service Continuity, Problem Management, Capacity Management, Change Management, Release Management, Financial Management, Incident Management, and Service Request.
